(19) United States
(12) Patent Application Publication
(10) Pub. No.: US 2026/0358175 A1
(43) Pub. Date: Nov. 12, 2026

(54) BOLOMETER ARRAY AND LIGHT DETECTION METHOD

(71) Applicant: NEC CORPORATION, Tokyo (JP)

(72) Inventors: Tomo TANAKA, Tokyo (JP); Ryota Yuge, Tokyo (JP); Masahiko Sano, Tokyo (JP)

(73) Assignee: NEC CORPORATION, Tokyo (JP)

(21) Appl. No.: 19/204,779

(22) Filed: May 12, 2025

(30) Foreign Application Priority Data
May 13, 2024 (JP) 2024-078163

(51) Int. Cl. G01J 5/20; G01J 5/02

(52) U.S. Cl. CPC G01J 5/20; G01J 5/023; G01J 2005/202

(57) ABSTRACT

A bolometer array includes a plurality of bolometers and a substrate on which the plurality of bolometers are arranged, wherein each of the bolometers comprises a first electrode, a second electrode provided across an inter-electrode region from the first electrode; a carbon nanotube film connected to the first electrode and the second electrode; a light receiving portion covering at least a portion of a surface on which the first electrode, the second electrode, and the carbon nanotube film are provided; and a connection portion extending from the light receiving portion to the carbon nanotube film, and the plurality of bolometers include: a first bolometer that converts a first wavelength included in a detection target light into heat at the light receiving portion by using the first wavelength as an absorption target wavelength; and a second bolometer having a wavelength band for photothermal conversion different from that of the first bolometer.

### CROSS-REFERENCE TO RELATED APPLICATIONS

This application is based upon and claims the benefit of priority from Japanese patent application No. 2024-078163, filed on May 13, 2024, the disclosure of which is incorporated herein in its entirety by reference.

### TECHNICAL FIELD

The present disclosure relates to a bolometer array and a light detection method.

### BACKGROUND ART

It is widely known that bolometers are used to detect infrared rays.

For example, Japanese Unexamined Patent Application Publication No. 2022-25052 (Patent Document 1) discloses a bolometer having a bolometer film whose resistance changes with an increase in temperature, and a method for manufacturing the same. The bolometer film of the bolometer disclosed in Patent Document 1 is, for example, a carbon nanotube film.

The sensor for acquiring the infrared image includes, for example, a bolometer array including a plurality of bolometers. Infrared radiation includes several typical wavelength bands. The information obtained differs depending on the wavelength band. For this reason, by installing two or more cameras and equipping each camera with a bolometer array that detects a different wavelength band, it is possible to obtain two or more images containing different information. However, in such a case, parallax occurs between two or more images. This makes the process of combining multiple images complicated.

### SUMMARY

An object of the present disclosure is to provide a bolometer array and a light detection method that solves the above-mentioned problems.

A bolometer array according to one aspect of the present disclosure is provided with a plurality of bolometers, and a substrate on which the plurality of bolometers are arranged, wherein each of the bolometers is provided with: a first electrode; a second electrode provided across an inter-electrode region from the first electrode; a carbon nanotube film connected to the first electrode and the second electrode; a light receiving portion covering at least a portion of a surface on which the first electrode, the second electrode, and the carbon nanotube film are provided; and a connection portion extending from the light receiving portion to the carbon nanotube film, and the plurality of bolometers include: a first bolometer that converts a first wavelength included in a detection target light into heat at the light receiving portion by using the first wavelength as an absorption target wavelength; and a second bolometer having a wavelength band for photothermal conversion different from that of the first bolometer.

A light detection method according to one aspect of the present disclosure, wherein in a bolometer array provided with a first bolometer and a second bolometer as bolometers, each of which comprises: a first electrode; a second electrode provided across an inter-electrode region from the first electrode; a carbon nanotube film connected to the first electrode and the second electrode; a light receiving portion covering at least a portion of a surface on which the first electrode, the second electrode, and the carbon nanotube film are provided; and a connection portion extending from the light receiving portion to the carbon nanotube film, the method detects different wavelength bands of the detection target light by the first bolometer and the second bolometer.

### BRIEF DESCRIPTION OF THE DRAWINGS

FIG. 1 is a schematic plan view showing an example of a bolometer array according to the present disclosure.

FIG. 2 is a schematic plan view showing an example of a bolometer array according to the present disclosure.

FIG. 3 is a schematic cross-sectional view showing an example of a first bolometer included in the bolometer array according to the present disclosure.

FIG. 4 is a schematic plan view including the inter-electrode region of a bolometer according to the present disclosure.

FIG. 5 is a schematic cross-sectional view of a light receiving portion included in a bolometer according to the present disclosure.

FIG. 6 is a schematic cross-sectional view showing an example of a second bolometer included in the bolometer array according to the present disclosure.

FIG. 7 is a flowchart illustrating an example of a method for manufacturing a bolometer array according to the present disclosure.

FIG. 8 is a schematic cross-sectional view showing an example of a bolometer array in the middle of being manufactured in Step S1 of the manufacturing method of the bolometer array according to the present disclosure.

FIG. 9 is a schematic cross-sectional view showing an example of a bolometer array in the middle of being manufactured in Step S2 of the manufacturing method of the bolometer array according to the present disclosure.

FIG. 10 is a schematic cross-sectional view showing an example of a bolometer array in the middle of being manufactured in Step S3 of the manufacturing method of the bolometer array according to the present disclosure.

FIG. 11 is a schematic cross-sectional view showing an example of a bolometer array in the middle of being manufactured in Step S4 of the manufacturing method of the bolometer array according to the present disclosure.

FIG. 12 is a schematic cross-sectional view showing an example of a bolometer array in the middle of being manufactured in Step S5 of the manufacturing method of the bolometer array according to the present disclosure.

FIG. 13 is a schematic cross-sectional view showing an example of a bolometer array in the middle of being manufactured in Step S6 of the manufacturing method of the bolometer array according to the present disclosure.

FIG. 14 is a schematic cross-sectional view showing an example of a bolometer array in the middle of being manufactured in Step S7 of the manufacturing method of the bolometer array according to the present disclosure.

FIG. 15 is a schematic cross-sectional view showing an example of a bolometer array in the middle of being manufactured in Step S8 of the manufacturing method of the bolometer array according to the present disclosure.

FIG. 16 is a schematic cross-sectional view showing an example of a bolometer array in the middle of being manufactured in Step S9 of the manufacturing method of the bolometer array according to the present disclosure.

FIG. 17 is a schematic cross-sectional view showing an example of a bolometer array in the middle of being manufactured in Step S10 of the manufacturing method of the bolometer array according to the present disclosure.

FIG. 18 is a schematic cross-sectional view showing an example of a bolometer array in the middle of being manufactured in Step S11 of the manufacturing method of the bolometer array according to the present disclosure.

FIG. 19 is a schematic cross-sectional view showing an example of a bolometer array in the middle of being manufactured in Step S12 of the manufacturing method of the bolometer array according to the present disclosure.

FIG. 20 is a schematic cross-sectional view showing an example of a bolometer array in the middle of being manufactured in Step S13 of the manufacturing method of the bolometer array according to the present disclosure.

FIG. 21 is a schematic cross-sectional view showing an example of a bolometer array in the middle of being manufactured in Step S14 of the manufacturing method of the bolometer array according to the present disclosure.

FIG. 22 is a schematic cross-sectional view showing an example of a first bolometer included in the bolometer array according to the present disclosure.

FIG. 23 is a schematic cross-sectional view showing an example of a second bolometer included in the bolometer array according to the present disclosure.

FIG. 24 is a schematic cross-sectional view showing an example of a first bolometer included in the bolometer array according to the present disclosure.

FIG. 25 is a schematic cross-sectional view showing an example of a second bolometer included in the bolometer array according to the present disclosure.

FIG. 26 is a schematic cross-sectional view showing an example of a first bolometer included in the bolometer array according to the present disclosure.

FIG. 27 is a schematic cross-sectional view showing an example of a second bolometer included in the bolometer array according to the present disclosure.

FIG. 28 is a schematic cross-sectional view showing an example of a bolometer array according to the present disclosure.

FIG. 29 is a schematic cross-sectional view showing an example of a bolometer array according to the present disclosure.

### EXAMPLE EMBODIMENT

Various embodiments according to the present disclosure will be described below with reference to the drawings.

### First Embodiment

A first embodiment of a bolometer array and a light detection method according to the present disclosure will be described below.

### (Bolometer Array)

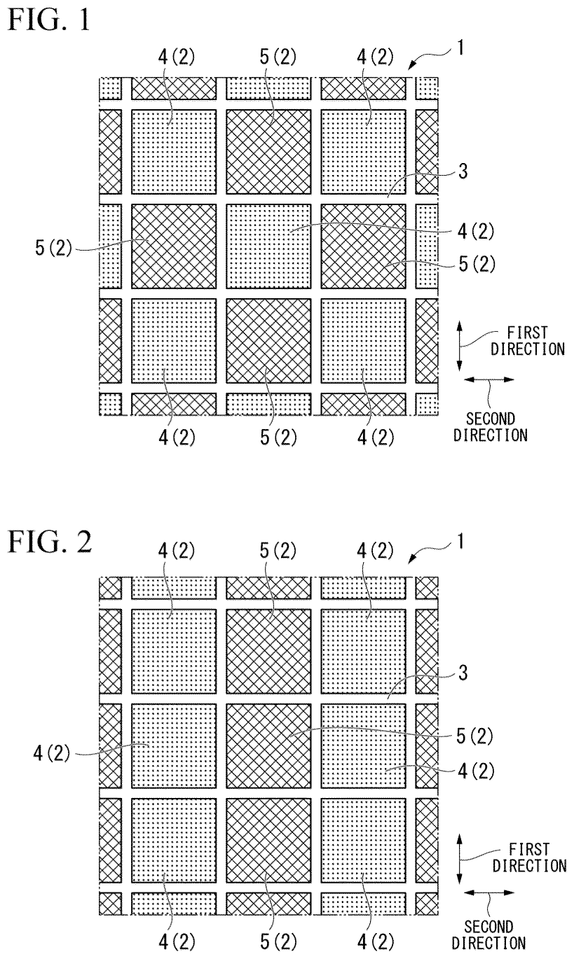

As shown in FIG. 1, a bolometer array 1 is provided with a plurality of bolometers 2 and a substrate 3.

The bolometer array 1 is a device for detecting infrared rays. The bolometer array 1 is applied to, for example, an uncooled infrared sensor.

Each bolometer 2 is an element that serves as a pixel of the bolometer array 1.

For example, the wavelength band of infrared light detected by the bolometer 2 may include 1 to 100 μm. Furthermore, for example, the wavelength band of infrared light detected by the bolometer 2 may include the terahertz band.

A plurality of bolometers 2 are provided on the substrate 3 and aligned in the plane.

For example, the substrate 3 may comprise an integrated readout circuit for reading out the change in electrical resistance from each bolometer 2.

Furthermore, the bolometer array 1 may include a sealing member that seals the area in which the multiple bolometers 2 are disposed so that the periphery of the multiple bolometers 2 is a vacuum.

The bolometers 2 are arranged along a first direction and a second direction in this disclosure. For example, the bolometers 2 are arranged at equal intervals in the first direction and the second direction.

The first direction and the second direction are directions within a plane in which the multiple bolometers 2 are arranged. The first direction and the second direction are perpendicular to each other.

The installation position of each bolometer 2 is not particularly limited. However, for convenience of explanation, the direction perpendicular to the first direction and the second direction is defined as the vertical direction.

The bolometer array 1 includes, as the bolometers 2, a first bolometer 4 and a second bolometer 5.

The first bolometer 4 and the second bolometer 5 detect different wavelength bands contained in the light L to be detected. For example, the first bolometer 4 may use the 8-14 μm wavelength band in the light L to be detected as the detection band. For example, the second bolometer 5 may use the 3-8 μm wavelength band in the light L to be detected as the detection band.

In the present disclosure, different wavelength bands include, for example, wavelength bands to be detected having different center wavelengths. However, in the present disclosure, different wavelength bands are not limited to the wavelength band detectable by the first bolometer 4 (detection band of the first bolometer 4) and the wavelength band detectable by the second bolometer 5 (detection band of the second bolometer 5) not overlapping. In other words, the wavelength band detectable by the first bolometer 4 and the wavelength band detectable by the second bolometer 5 may partially overlap. Furthermore, as long as the detectable wavelength bandwidths are different, one of the detectable wavelength band of the first bolometer 4 and the detectable wavelength band of the second bolometer 5 may include the entirety of the other.

Each bolometer 2 absorbs components included in a detection band out of the wavelength band included in the detection target light L, converts them into heat, and further outputs the temperature change due to the heat as an electrical signal. In other words, each bolometer 2 is an element that performs photoelectric conversion.

Of the wavelength band absorbed by the first bolometer 4, the wavelength that the first bolometer 4 primarily targets for absorption is referred to as a first wavelength λ1 in this disclosure.

Furthermore, in the wavelength band absorbed by the second bolometer 5, the wavelength that the second bolometer 5 primarily targets for absorption is referred to as a second wavelength λ2 in this disclosure.

However, the second bolometer 5 is capable of absorbing a wide wavelength band, and does not necessarily have to be set with a wavelength that is the main target for absorption.

The lower limit of the element size of each bolometer 2 is determined by the limit size in the microfabrication process.

Moreover, the upper limit of the element size of each bolometer 2 is determined by the limit size for maintaining a hollow structure.

The size of such a bolometer 2 in each of the first and second directions is, for example, 10 μm to 50 μm.

For example, as shown in FIG. 1, the first bolometers 4 and the second bolometers 5 may be arranged alternately in the first direction, and the first bolometers 4 and the second bolometers 5 may be arranged alternately in the second direction.

Also, as shown in FIG. 2, the first bolometers 4 and the second bolometers 5 may be arranged alternately in the first direction, the first bolometers 4 may be arranged continuously in the second direction, and the second bolometers 5 may be arranged continuously in the second direction.

### (First Bolometer)

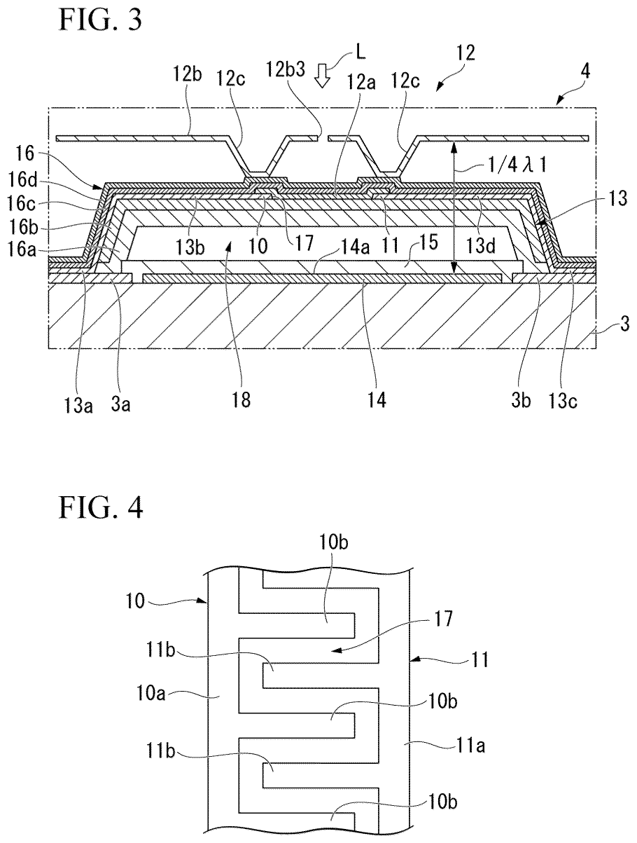

As shown in FIG. 3, the first bolometer 4 is disposed on a substrate 3. The first bolometer 4 is provided with a first electrode 10, a second electrode 11, a sensor portion 12, a wiring portion 13, a first reflective film 14, an insulating film 15, and a protective film 16.

### (Configuration of First Electrode)

The first electrode 10 is an electrode for passing an electric current through the sensor portion 12 to the second electrode 11.

As shown in FIG. 4, the first electrode 10 may include a first base end 10a and a plurality of first extension portions 10b. When viewed from above, each of the multiple first extension portions 10b extends from the first base end 10a. These first extension portions 10b are formed to be parallel to each other.

FIG. 3 is a cross-sectional view of a portion where the first extension portion 10b is not provided.

The first electrode 10 is made of a conductive material such as aluminum, copper, gold, or TiAlV.

The size of the first extension portion 10b may be any size within an appropriate range in terms of compatibility between the possibility of fine processing and effectively reducing resistance. Furthermore, the number of the first extension portions 10b may be any number within an appropriate range in terms of compatibility between the possibility of fine processing and effectively reducing resistance.

For example, the width of each of the first extension portions 10b is 0.2 μm to 20 μm, and preferably 0.2 μm to 1 μm.

For example, the length of each of the first extension portions 10b is 20% to 99% of the element size of the first bolometer 4, and preferably 30% to 70%.

For example, the number of the first extension portions 10b is 2 to 30, and preferably 5 to 15.

### (Configuration of Second Electrode)

The second electrode 11 is an electrode for passing an electric current through the sensor portion 12 to the first electrode 10.

As shown in FIG. 4, the second electrode 11 may include a second base end 11a and a plurality of second extension portions 11b. When viewed from above, each of the multiple second extension portions 11b extends from the second base end 11a. These second extension portions 11b are formed so as to be parallel to each other. These second extension portions 11b are formed so as to be parallel to each other.

FIG. 3 is a cross-sectional view of a portion where the second extension portion 11b is not provided.

The second electrode 11 is made of a conductive material such as aluminum, copper, gold, or TiAlV.

The size of the second extension portion 11b may be any size within an appropriate range in terms of compatibility between the possibility of fine processing and effectively reducing resistance. Furthermore, the number of the second extension portions 11b may be any number within an appropriate range in terms of compatibility between the possibility of fine processing and effectively reducing resistance.

For example, the width of each of the second extension portions 11b is 0.2 μm to 20 μm, and preferably 0.2 μm to 1 μm.

For example, the length of each of the second extension portions 11b is 20% to 99% of the element size of the first bolometer 4, and preferably 30% to 70%.

For example, the number of the second extension portions 11b is 2 to 30, and preferably 5 to 15.

### (Inter-Electrode Area)

As shown in FIG. 4, the first extension portion 10b of the first electrode 10 is disposed between two second extension portions 11b of the second electrode 11. In addition, the second extension portion 11b of the second electrode 11 is disposed between the two first extension portions 10b of the first electrode 10. In other words, the first electrode 10 and the second electrode 11 have a structure in which the plurality of first extension portions 10b and the plurality of second extension portions 11b are interlocked as a whole.

The first extension portion 10b is disposed with a gap between the second extension portions 11b and the second base end 11a.

Further, the second extension portion 11b is disposed with a gap between the first extension portions 10b and the first base end 10a.

As a result, a meandering interelectrode region 17 is formed between the first electrode 10 and the second electrode 11 when viewed from above.

In the present disclosure, the term “meandering” refers to a wavy shape. This includes stretching in an undulating manner.

For example, the inter-electrode region 17 extends in the second direction while repeatedly bending from one side in the first direction to the other side and then bending from the other side in the first direction to the one side.

For example, the width of the interelectrode region 17 may be 500 nm or more and 3 μm or less.

In the present disclosure, the “width of the interelectrode region 17” refers to the length of the interelectrode region 17 in the electrode opposing direction between the first electrode 10 and the second electrode 11.

### (Configuration of Sensor Portion)

The sensor portion 12 receives infrared rays and detects an amount related to the intensity of the received infrared rays as an amount of change in the electrical resistance value.

The sensor portion 12 has a function of converting the received infrared rays into heat and changing the electrical resistance value between the first electrode 10 and the second electrode 11 in relation to the converted heat.

The sensor portion 12 includes a carbon nanotube film 12a, a light receiving portion 12b, and a connection portion 12c.

### (Configuration of Carbon Nanotube Film)

The carbon nanotube film 12a functions as an electrical resistor whose electrical resistance value changes in relation to heat.

The carbon nanotube film 12a is electrically connected to the first electrode 10 and the second electrode 11 in the inter-electrode region 17.

The carbon nanotube film 12a is electrically connected to the first electrode 10 and the second electrode 11 over the inter-electrode region 17 so as to extend along the inter-electrode region 17.

For example, the carbon nanotube film 12a may be filled over the entire inter-electrode region 17 so as to extend in a meandering manner through the inter-electrode region 17.

For example, the thickness of the carbon nanotube film 12a may be preferably 0.7 nm or more and 50 nm or less, more preferably 0.7 nm or more and 10 nm or less, and further preferably 0.7 nm or more and 5 nm or less.

For example, the carbon nanotube film 12a may include single-walled carbon nanotubes. For example, the carbon nanotube film 12a may include semiconducting carbon nanotubes.

For example, the carbon nanotube film 12a may preferably contain 80% or more semiconducting carbon nanotubes, more preferably 90% or more semiconducting carbon nanotubes, and even more preferably 95% or more. At 95% or more, further improvement in characteristics is expected. On the other hand, in the range of 90% to less than 95%, it is possible to expect improved characteristics while reducing process costs.

For example, the carbon nanotube film 12a may contain semiconducting carbon nanotubes extracted by the electric-field-induced layer formation (ELF) method. The carbon nanotube film 12a may contain semiconducting carbon nanotubes extracted by other techniques, but preferably contains semiconducting carbon nanotubes extracted by the ELF method. In this case, for example, from the viewpoint of preventing adverse effects on the electrical characteristics of the first bolometer 4, a non-ionic surfactant may be used in the ELF method for extracting the semiconducting carbon nanotubes.

For example, the length of one of the semiconducting carbon nanotubes separated by the ELF method may be 10 nm to 1 μm.

For example, in the carbon nanotube film 12a, the semiconducting carbon nanotubes may be bundled. In this case, the length of the bundle may be about 100 nm to 10 μm.

For example, the carbon nanotube film 12a may include a carbon nanotube network film in which a plurality of carbon nanotubes are randomly oriented to form a network with each other.

In the present disclosure, the term “carbon nanotube network film” refers to a carbon nanotube film in which a plurality of carbon nanotubes are randomly oriented to form a network with each other.

### (Configuration of Light Receiving Portion)

The light receiving portion 12b is a portion at the top of the first bolometer 4, separated from the carbon nanotube film 12a, and extending like a roof above the carbon nanotube film 12a.

The light receiving portion 12b covers at least a part of the surface (one surface of the substrate 3) on which the first electrode 10, the second electrode 11 and the carbon nanotube film 12a are provided.

For example, the light receiving portion 12b may be formed to a size that covers the first electrode 10, the second electrode 11, and the carbon nanotube film 12a when viewed from above. Furthermore, the light receiving portion 12b may be formed to a size sufficient to cover the wiring portion 13 in addition to the first electrode 10, the second electrode 11, and the carbon nanotube film 12a when viewed from above.

For example, the light receiving portion 12b is formed in a plate shape except for the portion where the connection portion 12c is located.

For example, the position of the light receiving portion 12b in the vertical direction may be a position where the distance from the first reflecting film 14 to the light receiving portion 12b is one-quarter of the first wavelength λ1.

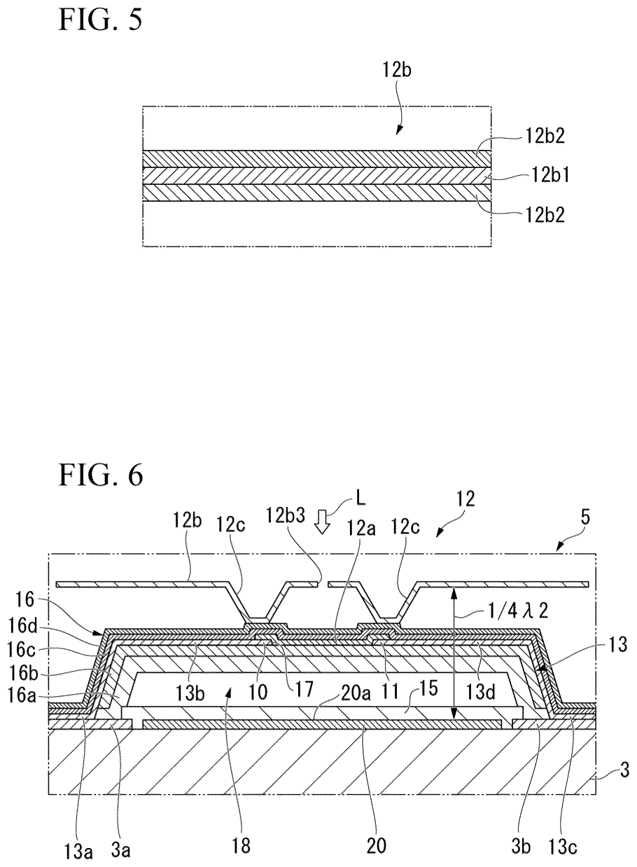

As shown in FIG. 5, the light receiving portion 12b may include a metal layer 12b1 and two insulating layers 12b2 that vertically sandwich the metal layer 12b1 therebetween. In this case, for example, it is preferable that the distance from the first reflection film 14 to the light receiving portion 12b is such that the distance from the upper surface 14a of the first reflection film 14 to the lower surface of the metal layer 12b1 is a quarter of the first wavelength λ1.

Furthermore, the light receiving portion 12b may be formed of a material, such as silicon nitride or titanium nitride, that has the function of converting the received infrared rays into heat.

The position of the light receiving portion 12b in the vertical direction may be such that the distance from the first reflecting film 14 to the light receiving portion 12b is an integer multiple of 2 or more of a quarter of the first wavelength λ1.

The outer periphery of the light receiving portion 12b may be rectangular or square.

The light receiving portion 12b may have a through hole 12b3 that penetrates in the vertical direction.

### (Connection Configuration)

The connection portion 12c extends from the light receiving portion 12b toward the carbon nanotube film 12a.

The connection portion 12c supports the light receiving portion 12b above the first electrode 10, the second electrode 11, and the carbon nanotube film 12a.

The upper end of the connection portion 12c is thermally connected to the light receiving portion 12b.

The lower end of the connection portion 12c is in contact with the surface of the protective film 16, and is thereby thermally connected to carbon nanotube film 12a via the protective film 16. Furthermore, the connection portion 12c may be further thermally connected to the first electrode 10 and the second electrode 11 via the protective film 16.

Specifically, the lower end of the connection portion 12c may be in contact with a portion of the upper surface of the protective film 16 that is provided across the upper surface of carbon nanotube film 12a, the upper surface of first electrode 10, and the upper surface of second electrode 11.

For example, the connection portion 12c may have an upper surface that is recessed downward from the light receiving portion 12b and a lower surface that protrudes downward relative to the upper surface, thereby extending recessed toward the carbon nanotube film 12a.

For example, the connection portion 12c may be integrally formed from the same material as the light receiving portion 12b.

### (Configuration of Wiring Portion)

The wiring portion 13 includes a first contact portion 13a, a first wiring 13b, a second contact portion 13c, and a second wiring 13d.

The wiring portion 13 supports the first electrode 10, the second electrode 11, and the sensor portion 12 in the air so that the first electrode 10, the second electrode 11, and the sensor portion 12 are separated from the substrate 3. As shown in FIG. 3, a cavity 18 is formed between the first electrode 10, the second electrode 11, and the sensor portion 12 and the substrate 3.

The first contact portion 13a, the first wiring 13b, and the first electrode 10 may be an integral thin film.

Similarly, the second contact portion 13c, the second wiring 13d, and the second electrode 11 may be integral with each other as a thin film.

The wiring portion 13 is made of a conductive material such as aluminum, copper, gold, or TiAlV.

The first contact portion 13a is connected to a pad 3a of the substrate 3. The first contact portion 13a is disposed below the first electrode 10, the second electrode 11, and the carbon nanotube film 12a.

The first wiring 13b extends so as to connect the first electrode 10 and the first contact portion 13a.

One end of the first wiring 13b is connected to the first base end 10a of the first electrode 10. The other end of the first wiring 13b is connected to the first contact portion 13a.

The first wiring 13b slopes so as to head upward as it extends from the other end to the one end.

The second contact portion 13c is connected to a pad 3b of the substrate 3. The second contact portion 13c is disposed below the first electrode 10, the second electrode 11, and the carbon nanotube film 12a.

The second wiring 13d extends so as to connect the second electrode 11 and the second contact portion 13c.

One end of the second wiring 13b is connected to the second base end 11a of the second electrode 11. The other end of the second wiring 13d is connected to the second contact portion 13c.

The second wiring 13b slopes so as to head upward as it extends from the other end to the one end.

### (Configuration of First Reflective Film)

The first reflective film 14 is a thin film disposed between the substrate 3 and the insulating film 15, and is located below the cavity 18.

The first reflective film 14 reflects, from below to above, the detection target light L that has passed through the sensor portion 12 from above to below.

Specifically, the first reflective film 14 reflects the detection target light L that is incident on the upper surface 14a.

The first reflective film 14 may be made of any material capable of reflecting the light L to be detected, and may be made of the same material as the pad 3a of the substrate 3, for example.

The first reflective film 14 is disposed parallel to a plane that includes the first direction and the second direction.

An upper surface 14a of the first reflecting film 14 is flat and is, for example, parallel to the light receiving portion 12b. Furthermore, the upper surface 14a of the first reflective film 14 may be located on the same plane as the upper surface of the pad 3a and the upper surface of the pad 3b.

The film thickness of the first reflective film 14 may be the same as that of the pads 3a and 3b of the substrate 3, for example.

### (Configuration of Insulating Film)

The insulating film 15 is formed to cover the upper surface of the substrate 3.

The insulating film 15 has openings that expose the pads 3a and 3b.

The insulating film 15 is formed so as to cover the first reflective film 14 from above. However, the insulating film 15 may have an opening through which a part or the whole of the first reflective film 14 is exposed.

### (Configuration of Protective Film)

The protective film 16 covers the carbon nanotube film 12a, the first electrode 10, the second electrode 11 and the wiring portion 13 in an integrated manner.

The protective film 16 is a thin film made of an insulating material such as silicon nitride, silicon oxide, or resin.

In addition, the protective film 16 may include a first lower protective film 16a and a second lower protective film 16b located below the carbon nanotube film 12a, the first electrode 10, the second electrode 11 and the wiring portion 13.

In addition, the protective film 16 may include a lower protective film consisting of one layer below the carbon nanotube film 12a, the first electrode 10, the second electrode 11, and the wiring portion 13.

The protective film 16 includes a first upper protective film 16c and a second upper protective film 16d located above the carbon nanotube film 12a, the first electrode 10, the second electrode 11, and the wiring portion 13.

In addition, the protective film 16 may include an upper protective film consisting of one layer located above carbon nanotube film 12a, the first electrode 10, the second electrode 11, and the wiring portion 13.

The first lower protective film 16a is located below the second lower protective film 16b. A cavity 18 is located below the first lower protective film 16a. The lower surface of the first lower protective film 16a forms the ceiling surface of the cavity 18.

The second lower protective film 16b is formed on the first lower protective film 16a and is in contact with the lower surfaces of the carbon nanotube film 12a, the first electrode 10, the second electrode 11, and the wiring portion 13.

The first upper protective film 16c is located below the second upper protective film 16d. The first upper protective film 16c is in contact with the top surfaces of carbon nanotube film 12a, the first electrode 10, the second electrode 11, and the wiring portion 13.

The second upper protective film 16d is formed on the first upper protective film 16c. The second upper protective film 16d is in contact with the lower portion of the connection portion 12c of the sensor portion 12 from above.

### (Second Bolometer)

As shown in FIG. 6, the second bolometer 5, like the first bolometer 4, is provided with the first electrode 10, the second electrode 11, the sensor portion 12, the wiring portion 13, the insulating film 15, and the protective film 16.

Furthermore, compared to the first bolometer 4, the second bolometer 5 includes a second reflective film 20 instead of the first reflective film 14.

### (Configuration of Second Reflective Film)

The second reflective film 20 is a thin film disposed between the substrate 3 and the insulating film 15, and is located below the cavity 18.

The second reflective film 20 reflects, from below to above, the detection target light L that has passed through the sensor portion 12 from above to below.

Specifically, the second reflective film 20 reflects the detection target light L that is incident on the upper surface 20a.

The second reflective film 20 may be made of any material capable of reflecting the light L to be detected, and may be made of the same material as the pad 3a of the substrate 3, for example.

The second reflective film 20 is disposed parallel to a plane that includes the first direction and the second direction.

An upper surface 20a of the second reflecting film 20 is flat and is, for example, parallel to the light receiving portion 12b. Furthermore, the upper surface 20a of the second reflective film 20 may be located on the same plane as the upper surface of the pad 3a and the upper surface of the pad 3b.

The film thickness of the second reflective film 20 may be the same as that of the pads 3a and 3b of the substrate 3, for example.

As shown in FIG. 6, in the second bolometer 5, the position of the light receiving portion 12b in the vertical direction may be a position where the distance from the second reflecting film 20 to the light receiving portion 12b is one-quarter of the second wavelength λ2.

For example, the distance from the second reflective film 20 to the light receiving portion 12b is preferably such that the distance from the upper surface 20a of the second reflective film 20 to the lower surface of the metal layer 12b1 is one-quarter of the second wavelength λ2.

The position of the light receiving portion 12b in the vertical direction may be such that the distance from the second reflecting film 20 to the light receiving portion 12b is an integer multiple of 2 or more of one-quarter of the second wavelength λ2.

### (Method of Manufacturing Bolometer Array)

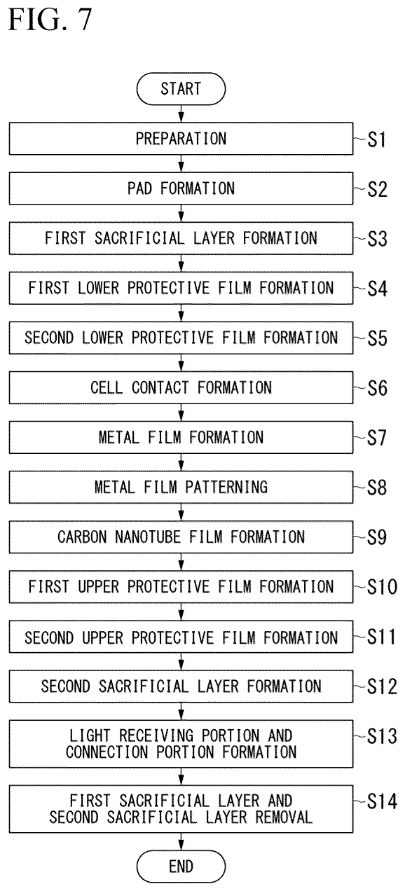

As shown in FIG. 7, the method of manufacturing the bolometer array 1 includes, for example, steps S1 to S14.

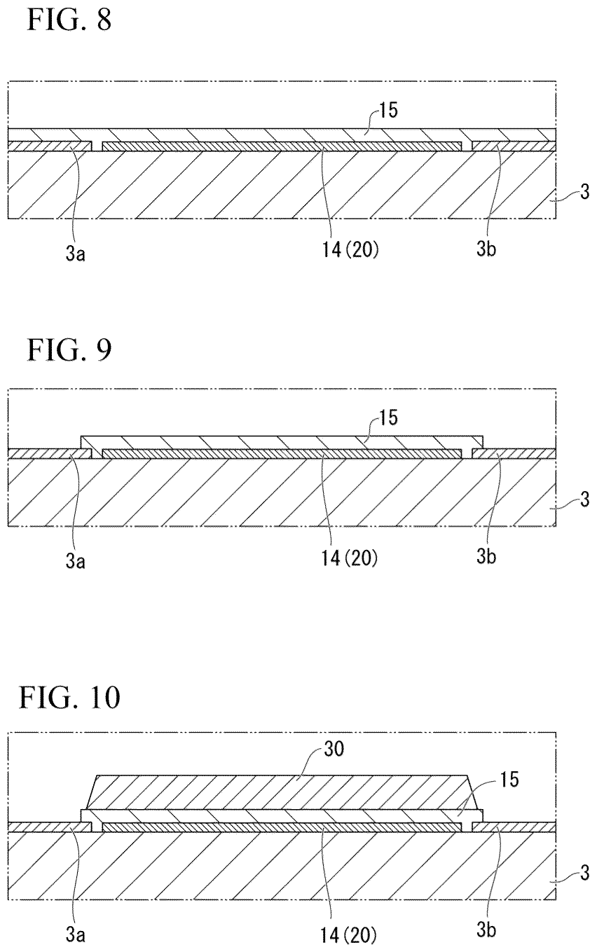

First, as shown in FIG. 8, the manufacturer prepares a substrate 3 having a metal layer that will become the pads 3a and 3b and a metal layer that will become a reflective film (first reflective film 14 or second reflective film 20), and the surface of which is covered with the insulating film 15 (Step S1).

The process shown in FIG. 8 is the same for the region where the first bolometer 4 is formed and the region where the second bolometer 5 is formed.

Following the execution of Step S1, the manufacturer forms the pads 3a and 3b on the substrate 3 as shown in FIG. 9 (Step S2). The manufacturer forms openings in parts of the insulating film 15 to expose the metal layer that will become the pads 3a and 3b.

The process shown in FIG. 9 is the same for the region where the first bolometer 4 is formed and the region where the second bolometer 5 is formed.

Following the execution of Step S2, the manufacturer forms a first sacrificial layer 30 on the insulating film 15 as shown in FIG. 10 (Step S3). The first sacrificial layer 30 is a layer that is removed in a later process to form the cavity 18. The first sacrificial layer 30 is formed of, for example, an organic polyimide.

The thickness of the first sacrificial layer 30 may be determined according to the distance from the reflective film to the light receiving portion 12b. For example, in the region where the first bolometer 4 is formed, the thickness of the first sacrificial layer 30 may be determined so that the distance from the first reflecting film 14 to the light receiving portion 12b is one-quarter of the first wavelength λ1. In addition, in the region where the first bolometer 4 is formed, the thickness of the first sacrificial layer 30 may be determined so that the distance from the first reflective film 14 to the light receiving portion 12b is an integer multiple of 2 or more of one-quarter of the first wavelength λ1.

Furthermore, in the region where the second bolometer 5 is formed, the thickness of the first sacrificial layer 30 may be determined so that the distance from the second reflective film 20 to the light receiving portion 12b is one-quarter of the second wavelength λ2. In addition, in the region where the second bolometer 5 is formed, the thickness of the first sacrificial layer 30 may be determined so that the distance from the second reflective film 20 to the light receiving portion 12b is an integer multiple of 2 or more of one-quarter of the second wavelength λ2.

Furthermore, the thickness of the first sacrificial layer 30 may be the same in the region where the first bolometer 4 is formed and in the region where the second bolometer 5 is formed.

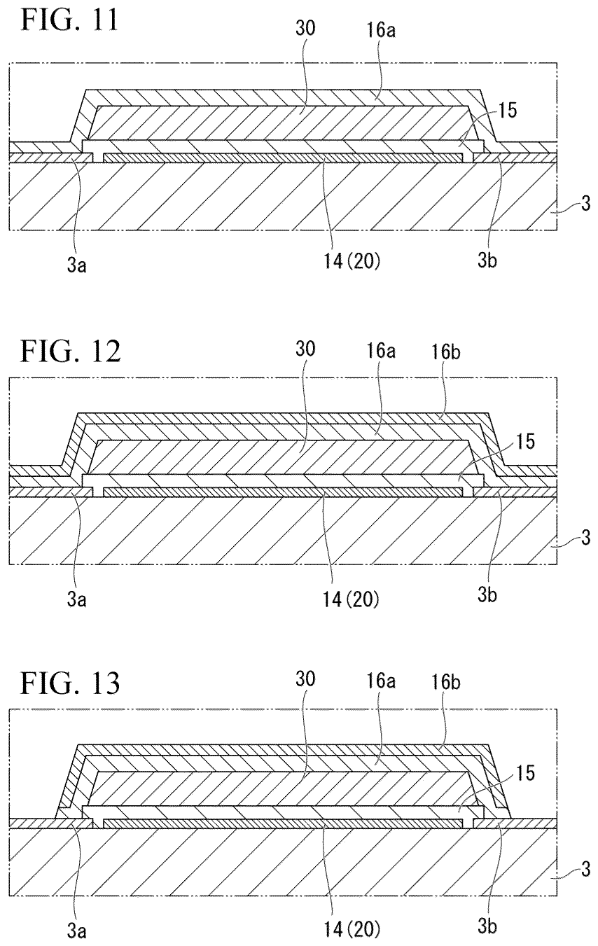

Following the execution of Step S3, the manufacturer forms a first lower protective film 16a on the first sacrificial layer 30 as shown in FIG. 11 (Step S4).

The process shown in FIG. 11 is the same for the region where the first bolometer 4 is formed and the region where the second bolometer 5 is formed.

Following the execution of Step S4, the manufacturer forms the second lower protective film 16b on the first lower protective film 16a, as shown in FIG. 12 (Step S5).

The process shown in FIG. 12 is the same for the region where the first bolometer 4 is formed and the region where the second bolometer 5 is formed.

Following execution of Step S5, the manufacturer forms openings (cell contacts) exposing the pads 3a and 3b in the first lower protective film 16a and the second lower protective film 16b as shown in FIG. 13 (Step S6).

The process shown in FIG. 13 is the same for the region where the first bolometer 4 is formed and the region where the second bolometer 5 is formed.

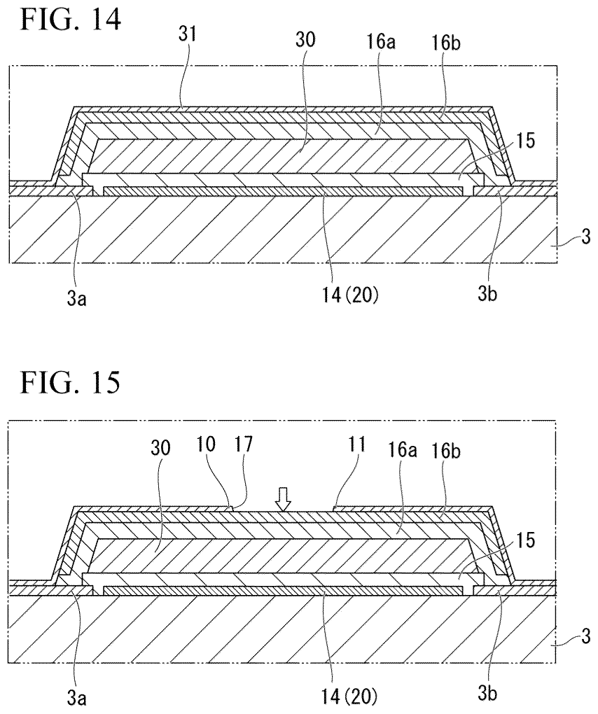

Following the execution of Step S6, the manufacturer forms the metal film 31 as shown in FIG. 14 (Step S7). The metal film 31 is a thin metal film for forming the first electrode 10, the second electrode 11 and the wiring portion 13. For example, the metal film 31 is made of a conductive material such as copper, gold, or TiAlV.

The process shown in FIG. 14 is the same for the region where the first bolometer 4 is formed and the region where the second bolometer 5 is formed.

Following execution of Step S7, the manufacturer performs patterning of the metal film 31 as shown in FIG. 15 (Step S8). For example, as shown in FIG. 15, the metal film 31 is patterned to remove the portions indicated by the arrows. The first electrode 10, the second electrode 11 and the wiring portion 13 are formed by patterning the metal film 31. The metal film 31 is patterned to form, for example, the meandering inter-electrode region 17.

The process shown in FIG. 15 is the same for the region where the first bolometer 4 is formed and the region where the second bolometer 5 is formed.

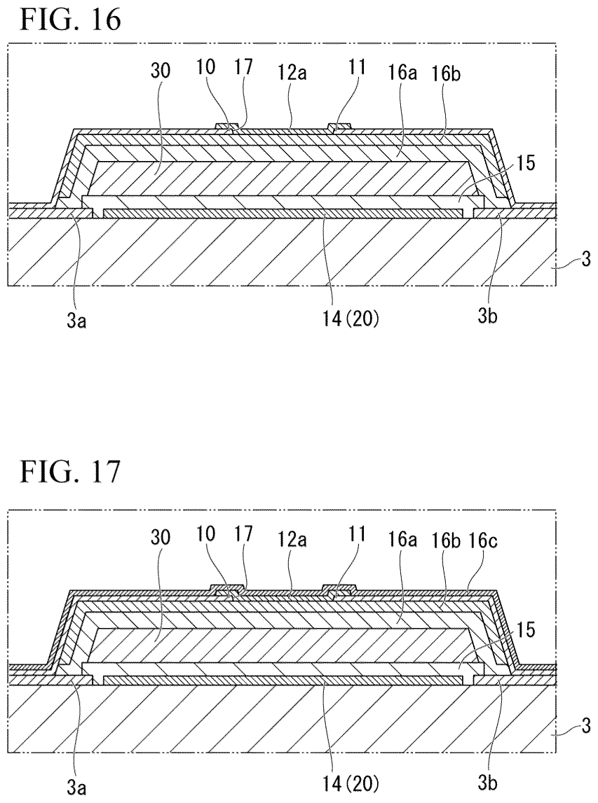

Following Step S8, the manufacturer forms the carbon nanotube film 12a as shown in FIG. 16 (Step S9).

The carbon nanotube film 12a is formed at least in the inter-electrode region 17.

The process shown in FIG. 16 is the same for the region where the first bolometer 4 is formed and the region where the second bolometer 5 is formed.

Following Step S9, the manufacturer forms the first upper protective film 16c as shown in FIG. 17 (Step S10).

The process shown in FIG. 17 is the same for the region where the first bolometer 4 is formed and the region where the second bolometer 5 is formed.

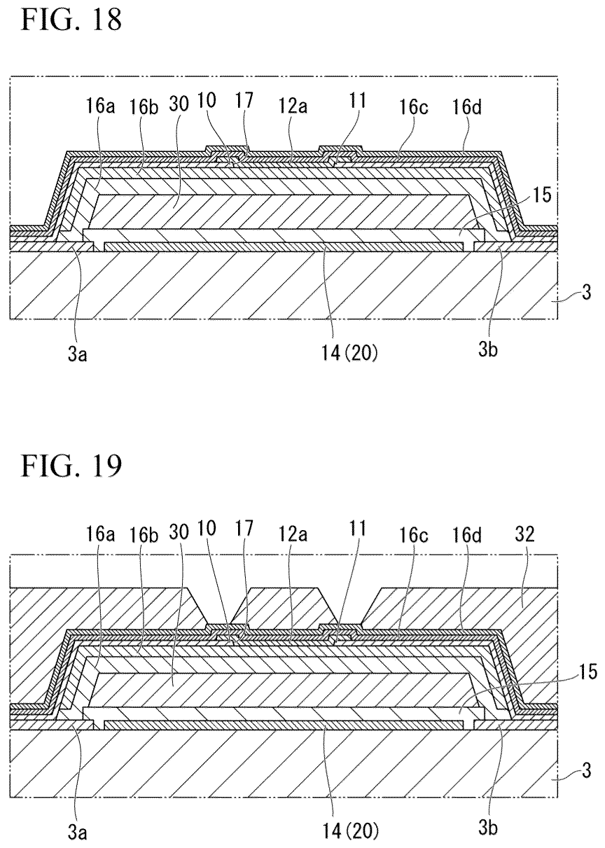

Following execution of Step S10, the manufacturer forms the second upper protective film 16d as shown in FIG. 18 (Step S11).

The process shown in FIG. 18 is the same for the region where the first bolometer 4 is formed and the region where the second bolometer 5 is formed.

Following the execution of Step S11, the manufacturer forms the second sacrificial layer 32 on the second upper protective film 16d as shown in FIG. 19 (Step S12). The second sacrificial layer 32 is a layer that is removed in a later process and serves to form a space between the second upper protective film 16d and the light receiving portion 12b. The second sacrificial layer 32 is formed of, for example, an organic POLYIMIDE.

The thickness of the second sacrificial layer 32 may be determined according to the distance from the reflective film to the light receiving portion 12b. For example, in the region where the first bolometer 4 is formed, the thickness of the second sacrificial layer 32 may be determined so that the distance from the first reflecting film 14 to the light receiving portion 12b is one-quarter of the first wavelength λ1. In addition, in the region where the first bolometer 4 is formed, the thickness of the first sacrificial layer 32 may be determined so that the distance from the first reflective film 14 to the light receiving portion 12b is an integer multiple of 2 or more of one-quarter of the first wavelength λ1.

Furthermore, in the region where the second bolometer 5 is formed, the thickness of the second sacrificial layer 32 may be determined so that the distance from the second reflective film 20 to the light receiving portion 12b is one-quarter of the second wavelength λ2. In addition, in the region where the second bolometer 5 is formed, the thickness of the second sacrificial layer 32 may be determined so that the distance from the second reflective film 20 to the light receiving portion 12b is an integer multiple of 2 or more of one-quarter of the second wavelength λ2.

Furthermore, the thickness of the second sacrificial layer 32 may be the same in the region where the first bolometer 4 is formed and in the region where the second bolometer 5 is formed.

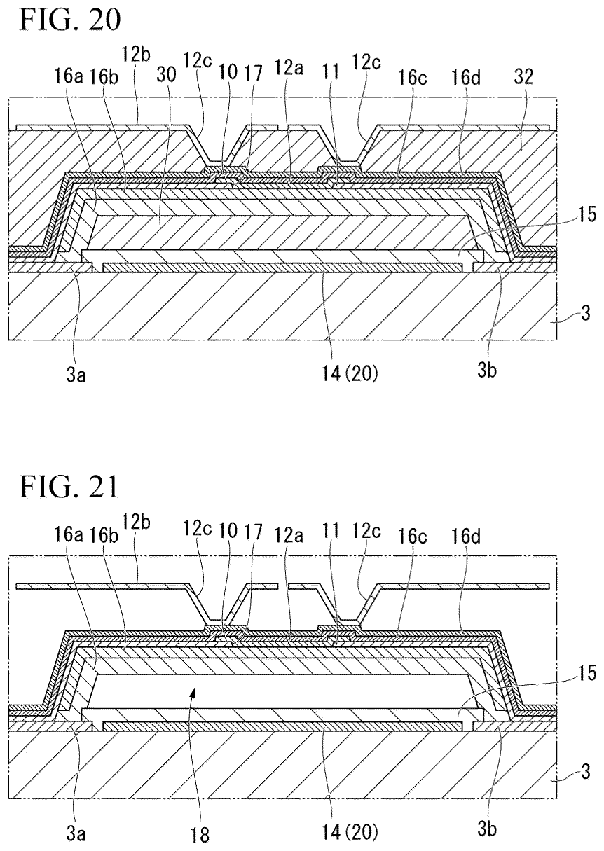

Following execution of Step S12, the manufacturer forms the light receiving portion 12b and the connection portion 12c on the second sacrificial layer 32, as shown in FIG. 20 (Step S13).

The process shown in FIG. 20 is the same for the region where the first bolometer 4 is formed and the region where the second bolometer 5 is formed.

Following execution of Step S13, the manufacturer removes the first sacrificial layer 30 and the second sacrificial layer 32 as shown in FIG. 21 (Step S14). For example, the first sacrificial layer 30 and the second sacrificial layer 32 may be removed using an oxygen plasma.

By removing the first sacrificial layer 30 and the second sacrificial layer 32, the bolometer array 1 having the cavity 18 is produced.

The process shown in FIG. 21 is the same for the region where the first bolometer 4 is formed and the region where the second bolometer 5 is formed.

### (Bolometer Array Operation)

The operation of the bolometer array 1 of the present embodiment will be described.

When light L to be detected is incident on the bolometer array 1, each of the first bolometer 4 and the second bolometer 5 converts the light L to be detected into heat at the light receiving portion 12b.

The first bolometer 4 absorbs the first wavelength λ1 as a target wavelength at the light receiving portion 12b and converts it into heat. For example, when the distance from the first reflecting film 14 to the light receiving portion 12b is one-quarter of the first wavelength λ1, the first bolometer 4 has a structure that optically resonates with the first wavelength λ1. Therefore, the first bolometer 4 mainly absorbs the light of the first wavelength λ1 and converts it into heat. Also, when the distance from the first reflecting film 14 to the light receiving portion 12b is an integer multiple of 2 or more of one-quarter of the first wavelength λ1, the first bolometer 4 has a structure that optically resonates with the first wavelength λ1.

The second bolometer 5 absorbs the second wavelength λ2 as a target wavelength at the light receiving portion 12b and converts it into heat. For example, when the distance from the second reflecting film 20 to the light receiving portion 12b is one-quarter of the second wavelength λ2, the second bolometer 5 has a structure that optically resonates with the second wavelength λ2. Therefore, the second bolometer 5 mainly absorbs the second wavelength λ2 and converts it into heat. Also, when the distance from the second reflecting film 20 to the light receiving portion 12b is an integer multiple of 2 or more of one-quarter of the second wavelength λ2, the second bolometer 5 has a structure that optically resonates with the second wavelength λ2.

Heat generated in the light receiving portions 12b of the first bolometer 4 and the second bolometer 5 is transmitted through the connection portion 12c and, via the protective film 16, heats the carbon nanotube film 12a.

When the carbon nanotube film 12a is heated, the electrical resistance value of the carbon nanotube film 12a changes.

The first bolometer 4 and the second bolometer 5 electrically detect the change in the electrical resistance value of the carbon nanotube film 12a in the inter-electrode region 17 by passing a current between the first electrode 10 and the second electrode 11, and output the detection result.

The first bolometer 4 and the second bolometer 5 have different absorption wavelength bands (detection bands). Therefore, an image based on the detection result output from the first bolometer 4 and the detection result output from the second bolometer 5 contain different information. For example, the images can be fused to generate a new image that contains the information of the two images.

In this manner, in the light detection method using the bolometer array 1 of the present embodiment, different wavelength bands of the detection target light L are detected by the first bolometer 4 and the second bolometer 5.

### (Action and Effects)

The bolometer array 1 of the present embodiment is provided with a plurality of the bolometers 2 and the substrate 3 on which the plurality of bolometers 2 are arranged side by side. Each bolometer 2 is provided with the first electrode 10, the second electrode 11, the carbon nanotube film 12a, the light receiving portion 12b, and the connection portion 12c. The second electrode 11 is provided with the inter-electrode region 17 sandwiched between the first electrode 10 and the second electrode 11. The carbon nanotube film 12a is connected to the first electrode 10 and the second electrode 11. The light receiving portion 12b covers at least a part of the surface on which the first electrode 10, the second electrode 11 and the carbon nanotube film 12a are provided. The connection portion 12c extends from the light receiving portion 12b to the carbon nanotube film 12a. The plurality of bolometers 2 also includes the first bolometer 4 and the second bolometer 5. The first bolometer 4 performs photothermal conversion at the light receiving portion 12b using the first wavelength λ1 in the light L to be detected as the target wavelength for absorption. The second bolometer 5 has a wavelength band for photothermal conversion that is different from that of the first bolometer 4.

Moreover, in the light detection method of the present embodiment, the bolometer array 1 is used to detect different wavelength bands of the detection target light L with the first bolometer 4 and the second bolometer 5.

The bolometer array 1 includes, as the plurality of bolometers 2, the first bolometer 4 and the second bolometer 5 having different absorption target wavelengths. Therefore, in the bolometer array 1, the two types of bolometers 2 are arranged on a plane on which the bolometers 2 are arranged, and two types of images can be obtained on the same plane.

Specifically, the bolometer array 1 can image a medium wavelength band, for example, from 3 to 8 μm, using the first bolometer 4 and can image a long wavelength band, for example, from 8 to 14 μm, using the second bolometer 5.

Since the first bolometer 4 and the second bolometer 5 are arranged in the same area, no parallax occurs between the image acquired by the first bolometer 4 and the image acquired by the second bolometer 5. That is, the bolometer array 1 of the present embodiment and the light detection method of the present embodiment can suppress the occurrence of parallax between the two images.

Also, for example, a configuration is conceivable in which a plurality of bolometers having the same wavelength band as a detection band are arranged, and a movable bandpass filter is provided in front of the bolometer array. A configuration including such a movable bandpass filter can change the wavelength band detected by the bolometer array by positioning the bandpass filter in the optical path of the light L to be detected or not. However, a configuration with a movable bandpass filter cannot detect different wavelength bands at the same time.

On the other hand, the bolometer array 1 includes, as the plurality of bolometers 2, the first bolometer 4 and the second bolometer 5 that have different absorption target wavelengths. Therefore, the bolometer array 1 can detect different wavelength bands at the same time and obtain images at the same time.

The bolometer array 1 and the light detection method of the present embodiment do not need to acquire images at different times, and therefore can acquire two types of images in a short time compared to a configuration that includes a movable bandpass filter. Therefore, by using the bolometer array 1, for example, a fusion image can be acquired in a short time, and response is improved.

The first bolometer 4 is also provided with the first reflective film 14. The first reflective film 14 is located on the opposite side to the light receiving portion 12b with the carbon nanotube film 12a interposed therebetween. Moreover, the first reflective film 14 reflects the light L to be detected. Furthermore, the distance from the first reflecting film 14 to the light receiving portion 12b is one-quarter of the first wavelength λ1.

In the bolometer array 1 and the light detection method of the present embodiment, the first bolometer 4 becomes the bolometer 2 having the first wavelength λ1 as the target absorption wavelength. Therefore, the bolometer array 1 of the present embodiment and the light detection method of the present embodiment can detect the first wavelength λ1.

Furthermore, the bolometer array 1 of the present embodiment and the light detection method of the present embodiment have a structure in which the first bolometer 4 optically resonates with respect to the first wavelength λ1. Therefore, the absorptance of the first bolometer 4 at the first wavelength λ1 can be improved.

In addition, the distance from the first reflecting film 14 to the light receiving portion 12b may be an integer multiple of 2 or more of one-quarter of the first wavelength λ1.

The second bolometer 5 also performs photothermal conversion in the light receiving portion 12b using the second wavelength λ2, which is different from the first wavelength λ1 and is included in the light to be detected, as the absorption target wavelength.

In the bolometer array 1 and the light detection method of the present embodiment, the second bolometer 5 serves as the bolometer 2 having the second wavelength λ2 as the target absorption wavelength. Therefore, the bolometer array 1 of the present embodiment and the light detection method of the present embodiment can detect the second wavelength λ2 different from the first wavelength λ1.

The second bolometer 5 also includes a second reflective film 20. The second reflective film 20 is located on the opposite side to the light receiving portion 12b with the carbon nanotube film 12a interposed therebetween. Moreover, the second reflective film 20 reflects the light L to be detected. Furthermore, the distance from the second reflecting film 20 to the light receiving portion 12b is one-quarter of the second wavelength λ2.

The bolometer array 1 of the present embodiment and the light detection method of the present embodiment have a structure in which the second bolometer 5 optically resonates with respect to the second wavelength λ2. Therefore, the absorptance of the second bolometer 5 at the second wavelength λ2 can be improved.

The distance from the second reflecting film 20 to the light receiving portion 12b may be an integer multiple of 2 or more of one-quarter of the first wavelength λ2.

In addition, in the bolometer array 1, the bolometers 2 are arranged in each of a first direction and a second direction perpendicular to the first direction, and the first bolometers 4 and the second bolometers 5 are arranged alternately in the first direction, and the first bolometers 4 and the second bolometers 5 are arranged alternately in the second direction. In such a bolometer array 1, the first bolometers 4 and the second bolometers are arranged alternately in both the first direction and the second direction. For this reason, the first bolometer 4 and the second bolometer 5 are disposed in a dispersed manner, and so the deviation between the image acquired by the first bolometer 4 and the image acquired by the second bolometer 5 is minimized.

In addition, the bolometers 2 may be arranged in a first direction and a second direction perpendicular to the first direction, the first bolometers 4 and the second bolometers 5 may be arranged alternately in the first direction, the first bolometers 4 may be arranged continuously in the second direction, and the second bolometers 5 may be arranged continuously in the second direction.

In such a bolometer array 1, the same type of bolometers 2 are arranged in the second direction. Therefore, when the output of each bolometer 2 is processed in sequence, the output of the same type of bolometer 2 can be processed consecutively. Therefore, it is possible to reduce the processing load of the detection results of the bolometer array 1.

### Second Embodiment

A second embodiment of a bolometer array and a light detection method according to the present disclosure will be described below.

In the description of the present embodiment, the description of the same parts as those in the first embodiment will be omitted or simplified.

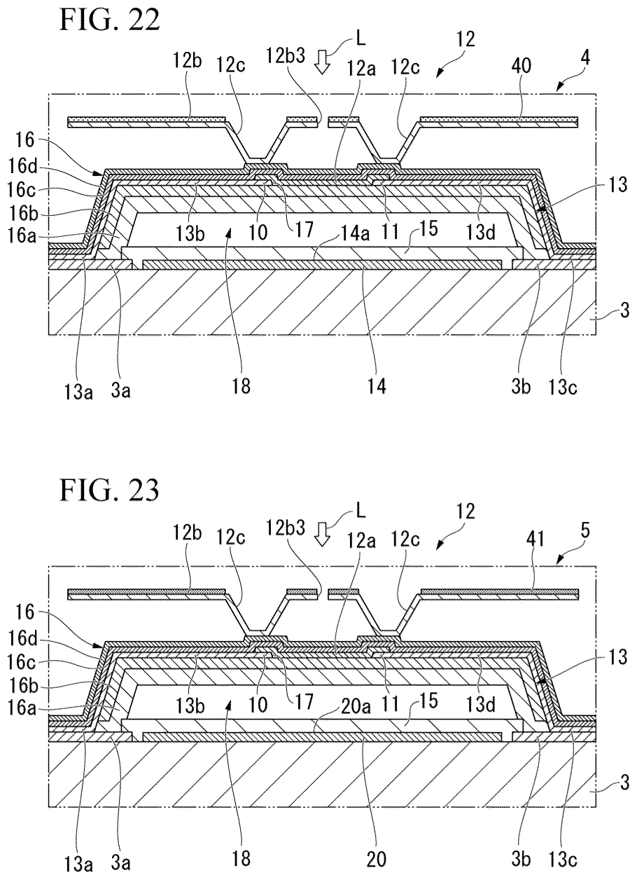

As shown in FIG. 22, in the present embodiment, the light receiving portion 12b of the first bolometer 4 is provided with a first wavelength absorbing member 40.

The first wavelength absorbing member 40 is a member that absorbs the component of the detection target light L that includes the first wavelength λ1 and converts it into heat.

For example, the first wavelength absorbing member 40 may be formed on the insulating layer 12b2 shown in FIG. 5. The first wavelength absorption member 40 may be formed on the metal layer 12b1 instead of on the insulating layer 12b2.

For example, the first wavelength absorbing member 40 may be formed below the insulating layer 12b2 shown in FIG. 5 in addition to being formed above the insulating layer 12b2 shown in FIG. 5.

As shown in FIG. 23, in the present embodiment, the light receiving portion 12b of the second bolometer 5 includes a second wavelength absorbing member 41.

The second wavelength absorbing member 41 is a member that absorbs the component including the second wavelength λ2 of the detection target light L and converts it into heat.

For example, the second wavelength absorbing member 41 may be formed on the insulating layer 12b2 shown in FIG. 5. The second wavelength absorbing member 41 may be formed on the metal layer 12b1 instead of on the insulating layer 12b2.

For example, the second wavelength absorbing member 41 may be formed below the insulating layer 12b2 shown in FIG. 5 in addition to being formed above the insulating layer 12b2 shown in FIG. 5.

In the present embodiment, the first bolometer 4 is provided with the first wavelength absorbing member 40. Therefore, the light receiving portion 12b of the first bolometer 4 has an improved absorptance for the first wavelength λ1 compared to a case where the first wavelength absorbing member 40 is not provided. Therefore, in the present embodiment, the first bolometer 4 has improved detection sensitivity.

In the present embodiment, the second bolometer 5 is provided with the second wavelength absorbing member 41. Therefore, the light receiving portion 12b of the second bolometer 5 has an improved absorptance for the second wavelength λ2 compared to a case where the second wavelength absorbing member 41 is not provided. Therefore, in the present embodiment, the second bolometer 5 has improved detection sensitivity.

The first wavelength absorbing member 40 and the second wavelength absorbing member 41 can be, for example, a thin film member that utilizes plasmon absorption. Plasmon absorption is the effect of metal particles absorbing light of specific wavelengths. For example, a thin film member that absorbs the first wavelength λ1 by the action of plasmon absorption can be used as the first wavelength absorbing member 40. Furthermore, a thin film member that absorbs the second wavelength λ2 by the action of plasmon absorption can be used as the second wavelength absorbing member 41.

Furthermore, a thin film member whose absorption wavelength can be changed by controlling the structure of the patch antenna can be used as a thin film member that utilizes plasmon absorption.

Furthermore, a metal matching film, whose absorption wavelength can be changed by changing the thickness of the metal thin film, can be used as a thin film member that utilizes plasmon absorption.

Furthermore, a thin film member in which the absorption wavelength can be changed by graphene can be used as a thin film member that utilizes plasmon absorption.

Moreover, the first wavelength absorption member 40 and the second wavelength absorption member 41 can be, for example, an antenna that orients carbon nanotubes and absorbs infrared radiation using plasmon resonance.

### (Modification)

For example, when the first wavelength absorbing member 40 has a high absorptance for the first wavelength λ1, the distance from the light receiving portion 12b of the first bolometer 4 to the first reflecting film 14 may be changed from one-quarter of the first wavelength λ1. Furthermore, for example, when first wavelength λ1 absorptance of the first wavelength absorbing member 40 is high, the first bolometer 4 does not need to include the first reflecting film 14.

Furthermore, when the second wavelength absorbing member 41 has a high absorptance for the second wavelength λ2, the distance from the light receiving portion 12b of the second bolometer 5 to the second reflecting film 20 may be changed from one-quarter of the second wavelength λ2. Furthermore, for example, when the second wavelength absorbing member 41 has a high absorptance for the second wavelength λ2, the second bolometer 5 does not need to include the second reflecting film 20.

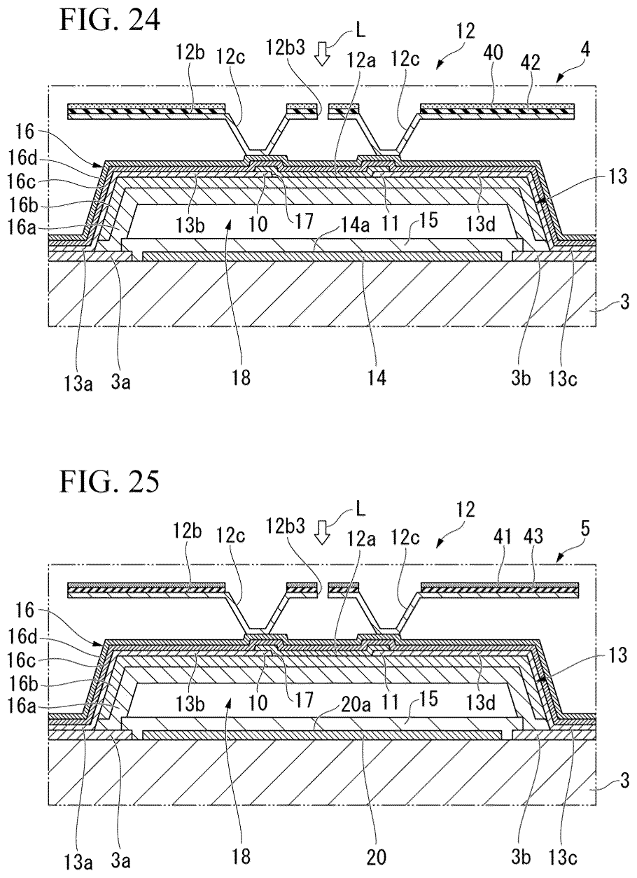

Furthermore, when the absorption rate of the first wavelength λ1 of the first wavelength absorbing member 40 is not high, the light receiving portion 12b of the first bolometer 4 may be provided with a first reflective layer 42 located below the first wavelength absorbing member 40, as shown in FIG. 24.

The first reflective layer 42 reflects the detection target light L that has passed through the first wavelength absorbing member 40 toward the first wavelength absorbing member 40. By providing the first reflective layer 42, the absorption rate of the first wavelength absorbing member 40 is further improved.

Furthermore, when the first reflective layer 42 is provided, the distance from the light receiving portion 12b of the first bolometer 4 to the first reflective film 14 may be changed from one-quarter of the first wavelength λ1.

Furthermore, when the first reflective layer 42 is provided, the first bolometer 4 does not need to include the first reflective film 14.

In addition, when the absorption rate of the second wavelength λ2 of the second wavelength absorption member 41 is not high, the light receiving portion 12b of the second bolometer 5 may be provided with a second reflective layer 43 located below the second wavelength absorption member 41, as shown in FIG. 25.

The second reflective layer 43 reflects the detection target light L that has passed through the second wavelength absorbing member 41 toward the second wavelength absorbing member 41. By providing the second reflective layer 43, the absorption rate of the first wavelength absorbing member 41 is further improved.

Furthermore, when the second reflective layer 43 is provided, the distance from the light receiving portion 12b of the second bolometer 5 to the second reflective film 20 may be changed from one-quarter of the second wavelength λ2.

Furthermore, when the second reflective layer 43 is provided, the second bolometer 5 does not need to include the second reflective film 20.

### Third Embodiment

A third embodiment of the bolometer array and light detection method according to the present disclosure will be described below.

In the description of the present embodiment, the description of the same parts as those in the first embodiment will be omitted or simplified.

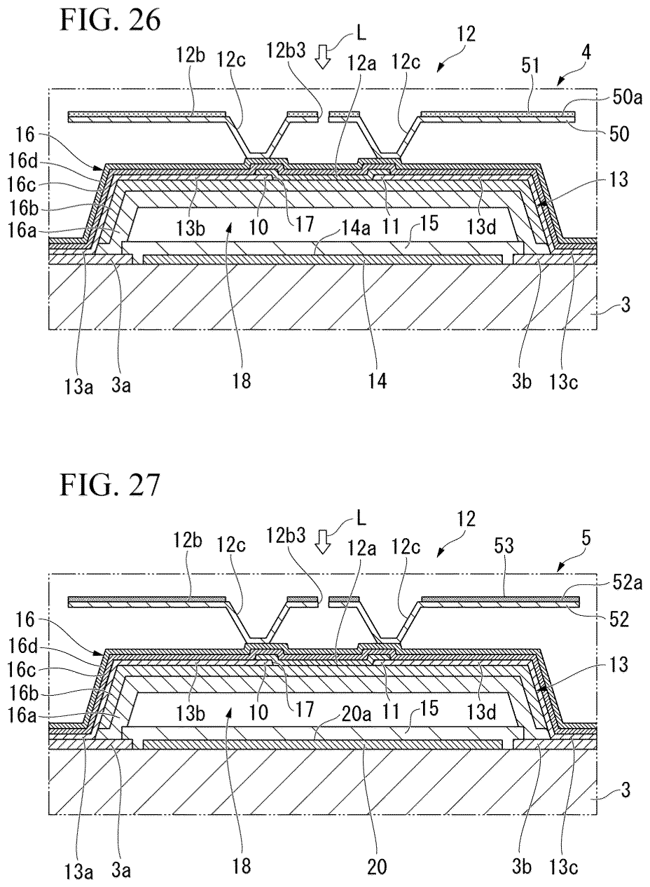

As shown in FIG. 26, in the present embodiment, the light receiving portion 12b of the first bolometer 4 is provided with a photothermal conversion layer 50 and a first wavelength transmitting member 51.

The photothermal conversion layer 50 is a layer that receives the light L to be detected and converts it into heat. That is, the photothermal conversion layer 50 absorbs a component of the wavelength band including the first wavelength λ1 of the detection target light L and converts it into heat. The photothermal conversion layer 50 is integrally connected to, for example, the connection portion 12c.

The first wavelength transmitting member 51 is formed so as to cover at least a portion of the light receiving surface 50a of the photothermal conversion layer 50.

The first wavelength transmitting member 51 selectively transmits the component of the wavelength band including the first wavelength λ1 of the detection target light L, and reflects components that are not transmitted.

As shown in FIG. 27, the light receiving portion 12b of the second bolometer 5 is provided with a photothermal conversion layer 52 and a second wavelength transmitting member 53.

The photothermal conversion layer 52 is a layer that receives the light L to be detected and converts it into heat. That is, the photothermal conversion layer 52 absorbs components of a wavelength band including the second wavelength λ2 of the detection target light L and converts them into heat. The photothermal conversion layer 52 is integrally connected to, for example, the connection portion 12c.

The second wavelength transmitting member 53 is formed so as to cover at least a portion of the light receiving surface 52a of the photothermal conversion layer 52.

The second wavelength transmitting member 53 selectively transmits the component of the wavelength band including the second wavelength λ2 of the detection target light L, and reflects components that are not transmitted.

In the present embodiment, the first bolometer 4 is provided with a first wavelength transmitting member 51. Therefore, the light receiving portion 12b of the first bolometer 4 can suppress absorption of the second wavelength λ2 in the photothermal conversion layer 50 compared to a case where the first wavelength transmitting member 51 is not provided. Therefore, in the present embodiment, the first bolometer 4 can selectively detect the first wavelength λ1.

In the present embodiment, the second bolometer 5 includes a second wavelength transparent member 53. Therefore, the light receiving portion 12b of the second bolometer 5 can suppress absorption of the first wavelength λ1 in the photothermal conversion layer 50 compared to a case where the second wavelength transmitting member 53 is not provided. Therefore, in the present embodiment, the second bolometer 5 can selectively detect the second wavelength λ2.

For example, when the first wavelength λ1 is included in the medium wavelength band of 3 to 8 μm, the first wavelength transmitting member 51 may be, for example, a thin film made of magnesium fluoride, a thin film made of aluminum oxide, or a metal matching film.

### (Modification)

For example, if the second wavelength λ2 is included in the long wavelength band of, for example, 8 to 14 μm, and the second bolometer 5 has high absorptance for the second wavelength λ2 and low absorptance for the first wavelength λ1 even without the second wavelength transparent member 53, the second bolometer 5 does not need to be provided with the second wavelength transparent member 53.

### Fourth Embodiment

A fourth embodiment of the bolometer array and light detection method according to the present disclosure will be described below.

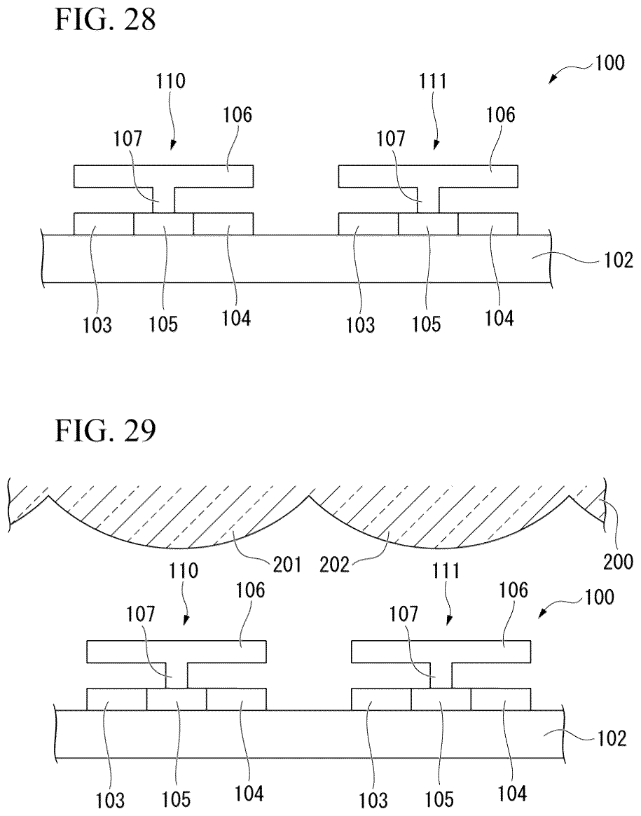

As shown in FIG. 28, a bolometer array 100 of the present embodiment includes a bolometer 110, a bolometer 111, and a substrate 102. In FIG. 28, there is one bolometer 110 and one bolometer 111 on the substrate 102, but the bolometer array 100 may include a plurality of bolometers 110 and a plurality of bolometers 111. The bolometer 110 includes a first electrode 103, a second electrode 104, a carbon nanotube film 105, a light receiving portion 106, and a connection portion 107. The bolometer 111 includes a first electrode 103, a second electrode 104, a carbon nanotube film 105, a light receiving portion 106, and a connection portion 107. The second electrode 104 is provided with an inter-electrode region 108 sandwiched between the first electrode 103 and the second electrode 104. The carbon nanotube film 105 is connected to the first electrode 103 and the second electrode 104. The light receiving portion 106 covers at least a part of the surface on which the first electrode 103, the second electrode 104 and the carbon nanotube film 105 are provided. The connection portion 107 extends from the light receiving portion 106 to the carbon nanotube film 105. The first bolometer 110 performs photothermal conversion at the light receiving portion 106 using the first wavelength λ1 in the light L to be detected as the target wavelength for absorption. The second bolometer 111 has a wavelength band for photothermal conversion that is different from that of the first bolometer 110.

In the light detection method of the present embodiment, the bolometer array 100 is used to detect different wavelength bands of the detection target light L with the first bolometer 110 and the second bolometer 111.

The bolometer array 100 includes, the plurality of first bolometers 110 and the plurality of second bolometers 111 having different absorption target wavelengths. Therefore, in the bolometer array 100, the two types of bolometers are arranged on a plane on which bolometers are arranged, and so two types of images can be obtained on the same plane.

Since the first bolometer 110 and the second bolometer 111 are arranged in the same area, no parallax occurs between the image acquired by the first bolometer 110 and the image acquired by the second bolometer 111. That is, the bolometer array 100 of the present embodiment and the light detection method of the present embodiment can suppress the occurrence of parallax between the two images.

### Fifth Embodiment

A fifth embodiment of the bolometer array and light detection method according to the present disclosure will be described below.

As shown in FIG. 29, a first lens 201 and a second lens 202 are provided on a sealing member 200 that seals the bolometer array 100.

The first lens 201 is a lens that guides the components of the detection target light L in a wavelength band that includes the first wavelength λ1 to the first bolometer 110.

The second lens 202 is a lens that guides the components of the wavelength band including the second wavelength λ2 of the detection target light L to the second bolometer 111.

In this manner, by providing the first lens 201 and the second lens 202 on the sealing member 200, the first bolometer 110 and the second bolometer 111 can detect different wavelength bands.

According to the above aspects, it is possible to suppress occurrence of parallax between two or more images.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

Some or all of the above-described embodiments may be described as, without being limited to, the following supplementary notes.

### (Supplementary Note 1)

A bolometer array comprising:
a plurality of bolometers; and
a substrate on which the plurality of bolometers are arranged,
wherein each of the bolometers comprises:
a first electrode;
a second electrode provided across an inter-electrode region from the first electrode;
a carbon nanotube film connected to the first electrode and the second electrode;
a light receiving portion covering at least a portion of the surface on which the first electrode, the second electrode, and the carbon nanotube film are provided; and
a connection portion extending from the light receiving portion to the carbon nanotube film,
and the plurality of bolometers include:
a first bolometer that converts a first wavelength included in the detection target light into heat at the light receiving portion by using the first wavelength as an absorption target wavelength; and
a second bolometer having a wavelength band for photothermal conversion different from that of the first bolometer.

### (Supplementary Note 2)

The bolometer array according to Supplementary Note 1,
wherein the first bolometer comprises:
a first reflective film located on the opposite side of the light receiving portion with the carbon nanotube film interposed therebetween and reflecting the detection target light; and
the distance from the first reflective film to the light receiving portion is one-quarter of the first wavelength.

### (Supplementary Note 3)

The bolometer array according to Supplementary Note 1 or 2,
wherein the light receiving portion of the first bolometer comprises:
a first wavelength absorbing member that absorbs a component including the first wavelength of the detection target light.

### (Supplementary Note 4)

The bolometer array according to Supplementary Note 3,
wherein the light receiving portion of the first bolometer comprises:
a first reflective layer that reflects the detection target light that has passed through the first wavelength absorbing member toward the first wavelength absorbing member.

### (Supplementary Note 5)

The bolometer array according to Supplementary Note 1 or 2,
wherein the light receiving portion of the first bolometer comprises:
a photothermal conversion layer that performs photothermal conversion; and
a first wavelength transmitting member that is formed so as to cover at least a part of the light receiving surface of the photothermal conversion layer and that selectively transmits a component including the first wavelength.

### (Supplementary Note 6)

The bolometer array according any one of supplementary notes 1 to 5,
wherein the second bolometer performs photothermal conversion in the light receiving portion using a second wavelength, which is different from the first wavelength and is included in the detection target light, as an absorption target wavelength.

### (Supplementary Note 7)

The bolometer array according to Supplementary Note 6,
wherein the second bolometer comprises:
a second reflective film located on the opposite side of the light receiving portion with the carbon nanotube film interposed therebetween and reflecting the detection target light; and
the distance from the second reflective film to the light receiving portion is one-quarter of the second wavelength.

### (Supplementary Note 8)

The bolometer array according to Supplementary Note 6 or 7,
wherein the light receiving portion of the second bolometer comprises:
a second wavelength absorbing member that absorbs a component including the second wavelength of the detection target light.

### (Supplementary Note 9)

The bolometer array according to Supplementary Note 8,
wherein the light receiving portion of the second bolometer comprises:
a second reflective layer that reflects the detection target light that has passed through the second wavelength absorbing member toward the first wavelength absorbing member.

### (Supplementary Note 10)

The bolometer array according to Supplementary Note 6 or 7,
wherein the light receiving portion of the second bolometer comprises:
a photothermal conversion layer that performs photothermal conversion; and
a second wavelength transmitting member that is formed so as to cover at least a part of the light receiving surface of the photothermal conversion layer and that selectively transmits a component including the second wavelength.

### (Supplementary Note 11)

The bolometer array according to any one of supplementary notes 1 to 10,
wherein the bolometers are arranged in a first direction and a second direction perpendicular to the first direction, and
the first bolometers and the second bolometers are alternately arranged in the first direction, and the first bolometers and the second bolometers are alternately arranged in the second direction.

### (Supplementary Note 12)

The bolometer array according to any one of supplementary notes 1 to 10,
wherein the bolometers are arranged in a first direction and a second direction perpendicular to the first direction;
the first bolometers and the second bolometers are alternately arranged in the first direction, and the first bolometers are continuously arranged in the second direction; and
the second bolometers are arranged consecutively in the second direction.

### (Supplementary Note 13)

A light detection method,
wherein in a bolometer array comprising a first bolometer and a second bolometer as bolometers, each of which comprises:
a first electrode;
a second electrode provided across an inter-electrode region from the first electrode;
a carbon nanotube film connected to the first electrode and the second electrode;
a light receiving portion covering at least a portion of the surface on which the first electrode, the second electrode, and the carbon nanotube film are provided; and
a connection portion extending from the light receiving portion to the carbon nanotube film,
the method detects different wavelength bands of the detection target light by the first bolometer and the second bolometer.

### (Supplementary Note 14)

The light detection method according to Supplementary Note 13,
wherein the first bolometer converts light into heat in the light receiving portion using a first wavelength included in the detection target light as an absorption target wavelength;
the first bolometer comprises a first reflective film located on the opposite side of the light receiving portion with the carbon nanotube film interposed therebetween and reflects the detection target light; and
the distance from the first reflective film to the light receiving portion is one-quarter of the first wavelength.

### (Supplementary Note 15)

The light detection method according to Supplementary Note 13 or 14,
wherein the first bolometer converts light into heat in the light receiving portion using a first wavelength included in the detection target light as an absorption target wavelength; and
the light receiving portion of the first bolometer comprises a first wavelength absorbing member that absorbs a component including the first wavelength of the detection target light.

### (Supplementary Note 16)

The light detection method according to Supplementary Note 15,
wherein the light receiving portion of the first bolometer comprises:
a first reflective layer that reflects the detection target light that has passed through the first wavelength absorbing member toward the first wavelength absorbing member.

### (Supplementary Note 17)

The light detection method according to Supplementary Note 13 or 14,
wherein the first bolometer converts light into heat in the light receiving portion using a first wavelength included in the detection target light as an absorption target wavelength; and
wherein the light receiving portion of the first bolometer comprises:
a photothermal conversion layer that performs photothermal conversion; and
a first wavelength transmitting member that is formed so as to cover at least a part of the light receiving surface of the photothermal conversion layer and that selectively transmits a component including the first wavelength.

### (Supplementary Note 18)

The light detection method according to any one of supplementary notes 13 to 17,
wherein the first bolometer converts light into heat in the light receiving portion using a first wavelength included in the detection target light as an absorption target wavelength; and
wherein the second bolometer performs photothermal conversion in the light receiving portion using a second wavelength, which is different from the first wavelength and is included in the detection target light, as an absorption target wavelength.

### (Supplementary Note 19)

The light detection method according to Supplementary Note 18,
wherein the second bolometer comprises:
a second reflective film located on the opposite side of the light receiving portion with the carbon nanotube film interposed therebetween and reflecting the detection target light; and

the distance from the second reflective film to the light receiving portion is one-quarter of the second wavelength.

### (Supplementary Note 20)

The light detection method according to Supplementary Note 18 or 19,
wherein the light receiving portion of the second bolometer comprises:
a second wavelength absorbing member that absorbs a component including the second wavelength of the detection target light.

### (Supplementary Note 21)

The light detection method according to Supplementary Note 20,
wherein the light receiving portion of the second bolometer comprises:
a second reflective layer that reflects the detection target light that has passed through the second wavelength absorbing member toward the first wavelength absorbing member.

### (Supplementary Note 22)

The light detection method according to Supplementary Note 18 or 19,
wherein the light receiving portion of the second bolometer comprises:
a photothermal conversion layer that performs photothermal conversion; and
a second wavelength transmitting member that is formed so as to cover at least a part of the light receiving surface of the photothermal conversion layer and that selectively transmits a component including the second wavelength.

### (Supplementary Note 23)

The light detection method according to any one of supplementary notes 13 to 22,
wherein the bolometers are arranged in a first direction and a second direction perpendicular to the first direction; and
the first bolometers and the second bolometers are alternately arranged in the first direction, and the first bolometers and the second bolometers are alternately arranged in the second direction.

### (Supplementary Note 24)

The light detection method according to any one of supplementary notes 13 to 22,
wherein the bolometers are arranged in a first direction and a second direction perpendicular to the first direction;
the first bolometers and the second bolometers are alternately arranged in the first direction, and the first bolometers are continuously arranged in the second direction; and
the second bolometers are arranged consecutively in the second direction.

What is claimed is:

1. A bolometer array comprising:
a plurality of bolometers; and
a substrate on which the plurality of bolometers are arranged,
wherein each of the bolometers comprises:
a first electrode;
a second electrode, wherein the first electrode and the second electrode are provided with an inter-electrode region therebetween;
a carbon nanotube film connected to the first electrode and the second electrode;
a light receiving portion covering at least a portion of a surface on which the first electrode, the second electrode, and the carbon nanotube film are provided; and
a connection portion extending from the light receiving portion to the carbon nanotube film,
and the plurality of bolometers include:
a first bolometer that converts a first wavelength included in a detection target light into heat at the light receiving portion by using the first wavelength as an absorption target wavelength; and
a second bolometer having a wavelength band for photothermal conversion different from that of the first bolometer.

2. The bolometer array according to claim 1,
wherein the first bolometer comprises a first reflective film located on an opposite side of the light receiving portion with the carbon nanotube film interposed therebetween and reflecting the detection target light; and
a distance from the first reflective film to the light receiving portion is one-quarter of the first wavelength.

3. The bolometer array according to claim 1,
wherein the light receiving portion of the first bolometer comprises a first wavelength absorbing member that absorbs a component including the first wavelength of the detection target light.

4. The bolometer array according to claim 1,
wherein the light receiving portion of the first bolometer comprises:
a photothermal conversion layer that performs photothermal conversion; and
a first wavelength transmitting member that is formed so as to cover at least a part of a light receiving surface of the photothermal conversion layer and that selectively transmits a component including the first wavelength.

5. The bolometer array according to claim 1,
wherein the second bolometer performs photothermal conversion in the light receiving portion using a second wavelength, which is different from the first wavelength and is included in the detection target light, as an absorption target wavelength.

6. The bolometer array according to claim 5,
wherein the second bolometer comprises:
a second reflective film located on an opposite side of the light receiving portion with the carbon nanotube film interposed therebetween and reflecting the detection target light; and
a distance from the second reflective film to the light receiving portion is one-quarter of the second wavelength.

7. The bolometer array according to claim 5,
wherein the light receiving portion of the second bolometer comprises a second wavelength absorbing member that absorbs a component including the second wavelength of the detection target light.

8. The bolometer array according to claim 5,
wherein the light receiving portion of the second bolometer comprises:
a photothermal conversion layer that performs photothermal conversion; and
a second wavelength transmitting member that is formed so as to cover at least a part of a light receiving surface of the photothermal conversion layer and that selectively transmits a component including the second wavelength.

9. The bolometer array according to claim 1,
wherein the bolometers are arranged in a first direction and a second direction perpendicular to the first direction; and
the first bolometers and the second bolometers are alternately arranged in the first direction, and the first bolometers and the second bolometers are alternately arranged in the second direction.

10. The bolometer array according to claim 3, wherein the light receiving portion of the first bolometer comprises a first reflective layer that reflects the detection target light that has passed through the first wavelength absorbing member toward the first wavelength absorbing member.

11. The bolometer array according to claim 8, wherein the light receiving portion of the second bolometer comprises a second reflective layer that reflects the detection target light that has passed through the second wavelength absorbing member toward the first wavelength absorbing member.

12. The bolometer array according to claim 1, wherein the bolometers are arranged in a first direction and a second direction perpendicular to the first direction,
wherein the first bolometers and the second bolometers are alternately arranged in the first direction, and the first bolometers are continuously arranged in the second direction, and
wherein the second bolometers are arranged consecutively in the second direction.

13. A light detection method,
wherein in a bolometer array comprising a first bolometer and a second bolometer as bolometers, each of which comprises:
a first electrode;
a second electrode, wherein the first electrode and the second electrode are provided with an inter-electrode region therebetween;
a carbon nanotube film connected to the first electrode and the second electrode;
a light receiving portion covering at least a portion of a surface on which the first electrode, the second electrode, and the carbon nanotube film are provided; and
a connection portion extending from the light receiving portion to the carbon nanotube film,
the method comprising detecting different wavelength bands of the detection target light by the first bolometer and the second bolometer.
